(19) United States
(12) Patent Application Publication
(10) Pub. No.: US 2019/0227568 A1
(43) Pub. Date: Jul. 25, 2019

(54) METHOD FOR OPERATING A MOTOR VEHICLE

(71) Applicant: AUDI AG, Ingolstadt (DE)

(72) Inventors: Harald ALTINGER, Gerolfing (DE); Florian SCHULLER, Ismaning (DE); Christian FEIST, Ingolstadt (DE)

(73) Assignee: AUDI AG, Ingolstadt (DE)

(21) Appl. No.: 16/328,971

(22) PCT Filed: Aug. 4, 2017
(86) PCT No.: PCT/EP2017/069830

§ 371 Date: Feb. 27, 2019

(30) Foreign Application Priority Data
Aug. 29, 2016 (DE) 10 2016 216 157.1

(51) Int. Cl. G05D 1/02; G01C 21/34

(52) U.S. Cl. CPC G05D 1/0276; B62D 15/0285; G01C 21/34; G05D 1/0212

(57) ABSTRACT

The present disclosure relates to a method for operating a motor vehicle, comprising the following steps:
ascertaining at least one path data record describing a respective traveled trajectory of the or a respective further motor vehicle, and transmitting the path data record to a vehicle-external memory device;
providing at least one guidance data record for the motor vehicle by the memory device, wherein each guidance data record is assigned to one of the trajectories and is ascertained as a function of the path data record describing the respective assigned trajectory; and
actuating the vehicle device of the motor vehicle as a function of the provided guidance data record or, if a plurality of guidance data records are provided by the memory device, of one of the provided guidance data records selected by the motor vehicle so as to output a driving suggestion, related to the assigned trajectory, to a driver of the motor vehicle and/or so as to carry out at least one driving intervention.

### TECHNICAL FIELD

The present disclosure relates to a method for operating a motor vehicle. In addition, the present disclosure relates to a motor vehicle and to a memory device.

### BACKGROUND

When certain driving maneuvers in motor vehicles are carried out in an automated or assisted manner, or when driving instructions are to be issued to a driver, this can take place based on a predefined trajectory which the motor vehicle is to follow. It is known in this regard that trajectories are learned by motor vehicles during normal operation, which is to say that a trajectory traveled by a driver can be stored in the motor vehicle for later use.

A corresponding procedure is described in DE 10 2014 018 189 A1, for example. According to this reference, a learned trajectory, to which further attributes have been added, can serve as a template for an automatic driving operation of the motor vehicle during a parking process.

Learning trajectories to be followed is particularly advantageous during a driving operation of the motor vehicle on private property. However, it is problematic, for example in the case where several different motor vehicles are to be parked on private property, that appropriate trajectories must be learned separately for each of these motor vehicles.

It is therefore the object of the present disclosure to provide a method by which the learning complexity can be reduced when multiple motor vehicles are used, which are to carry out certain driving maneuvers.

### SUMMARY

According to the present disclosure, the object is achieved by a method for operating a motor vehicle, comprising the following steps:

ascertaining at least one path data record describing a respective traveled trajectory of the or a respective further motor vehicle, and transmitting the path data record to a vehicle-external memory device;

providing at least one guidance data record for the motor vehicle by the memory device, wherein each guidance data record is assigned to one of the trajectories and is ascertained as a function of the path data record describing the respective assigned trajectory; and

actuating the vehicle device of the motor vehicle as a function of the provided guidance data record or, if several of the guidance data records are provided by the memory device, of one of the provided guidance data record selected by the motor vehicle so as to output a driving suggestion, related to the assigned trajectory, to a driver of the motor vehicle and/or so as to carry out at least one driving intervention.

### BRIEF DESCRIPTION OF THE DRAWING

FIG. 1 illustrates a motor vehicle and a two-garage, in accordance with some embodiments.

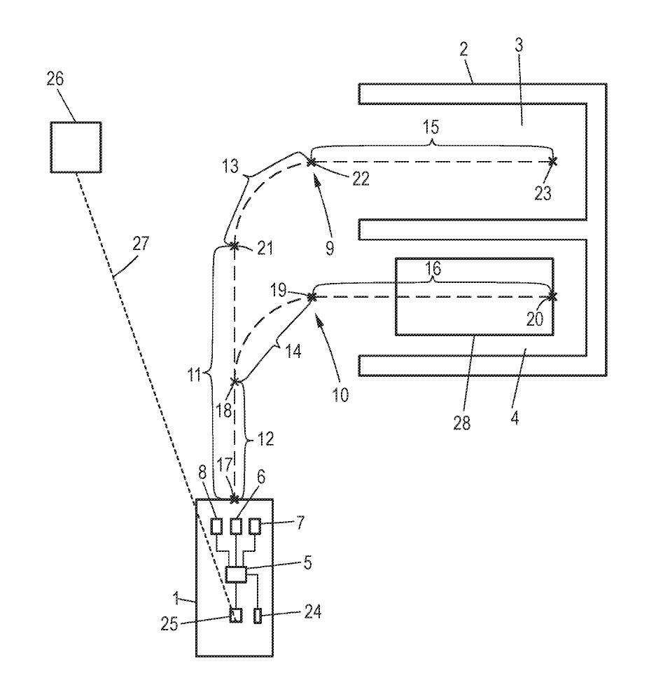

### DETAILED DESCRIPTION

According to the present disclosure, it is thus proposed not to store, or at least not to exclusively store, a learned trajectory or a path data record describing this trajectory locally in the motor vehicle that was used to negotiate the trajectory. Rather, the path data record is stored in a vehicle-external memory device. At a later point in time, a guidance data record, which may correspond to the path data record or is calculated therefrom, can be provided to the same and/or at least one other motor vehicle.

The path data record, which is to say the path data resulting from the traveled trajectory, can thus be used not only by the motor vehicle which was used to learn the trajectory, but also by further vehicles. As will be described in greater detail hereafter, it is possible in this regard to take the vehicle geometry of the motor vehicle receiving the guidance data record and/or the vehicle geometry of the motor vehicle that was used to originally travel the trajectory into consideration in the provision of the guidance data record and/or in the actuation of the vehicle device. In this way, it is possible to utilize the learned trajectories regardless of the driving geometry of the motor vehicle used in the specific case. As a result of the method according to the present disclosure, it is thus sufficient to learn a trajectory using a motor vehicle, whereupon the ascertained path data record can continue to be used in the future in the guidance of the same motor vehicle or other motor vehicles.

The vehicle-external memory device may be used to store path data records of a plurality of motor vehicles and/or users, or to provide guidance data records for a plurality of motor vehicles having respective users. So as to enable an automatic selection of guidance data records or facilitate a manual selection by a user, multiple approaches may be used. For example, path data records can each be assigned to certain users, so that these may be used in all motor vehicles used by this user. However, it is also possible for users to provide path data records for other users. Moreover, it is possible to already select a subgroup of the trajectories or of the assigned guidance data records as a function of the existing driving operation, and in particular of the instantaneous motor vehicle position, a selection being subsequently made from this subgroup automatically or by a user. So as to facilitate, in particular, a selection by a user, the individual trajectories can be assigned plain text names, for example in the form of a text string, within the scope of the ascertainment of the path data record or afterwards, which can be displayed, for example, to a user within the scope of a selection of a trajectory to be traveled. As an alternative, it would be possible, for example, to identify the individual trajectories by way of destinations or by way of designations of relevant objects in the surroundings of the trajectory ascertained from map data.

The memory device can also be designed so as to comprise multiple elements, which are connected, for example, via a network. For example, the memory device can be designed in the form of a cloud memory.

In the method according to the present disclosure, it is possible to ascertain path data records for multiple trajectories, wherein at least one piece of position information describing at least one position assigned to the trajectories is assigned to each of the trajectories, wherein a selection criterion, which is used to select the at least one trajectory for which a respective assigned guidance data record is ascertained and provided, and/or to select the guidance data record used to control the vehicle device, depends on the pieces of position information. The piece of position information can describe a starting point and/or an ending point of the trajectory and/or further waypoints of the trajectory. It is also possible for distance limits to be fixedly predefined or to be ascertained as part of the piece of position information, wherein the selection criterion, in particular, evaluates whether an ego position of the motor vehicle is located within these distance limits. The multiple path data records can, in particular, be ascertained by different motor vehicles.

A position detection device of the motor vehicle can ascertain a piece of ego position information describing the ego position of the motor vehicle, wherein the selection criterion additionally depends on the piece of ego position information. The piece of ego position information can be ascertained, for example, by way of a satellite-based positioning system, for example a GPS sensor. A guidance data record can be selected or ascertained for a trajectory when the assigned piece of position information describes a position that is disposed less than a predefined limit value apart from the ego position. In this way, it is possible to select trajectories for which guidance data records are determined which include waypoints, and in particular starting points, that are located close to the ego position of the motor vehicle and are thus particularly relevant for the subsequent guidance of the motor vehicle, or a guidance data record that is assigned to an appropriate trajectory can be selected.

Each of the pieces of position information can describe a target position at which the respective trajectory ends, wherein the selection criterion depends on the target positions. A corresponding evaluation is advantageous when a user predefines that the motor vehicle is to be guided to a certain destination since, in this way, only those trajectories that include appropriate target positions can be selected. It is also possible to check whether a target position of a trajectory is already occupied, for example by a further motor vehicle. In this case, the host motor vehicle is not to be guided to this target position, which is why corresponding trajectories cannot be taken into consideration.

The selection criterion can additionally depend on an operating input of a user detected on an operating device of the motor vehicle. For example, a user can make a selection from multiple offered trajectories or target positions assigned thereto, wherein a corresponding selection can either be provided to the memory device so as to predefine the selection of those trajectories for which guidance data records are to be provided, or can be further processed within the motor vehicle so as to select one of multiple provided guidance data records.

In the method according to the present disclosure, a piece of occupancy information can be ascertained, which describes a position occupied by a motor vehicle to be taken into consideration, whereupon the selection of the at least one trajectory for which an assigned guidance data record is ascertained and provided and/or the selection of the guidance data record used to control the vehicle device depends on the piece of occupancy information. Such a procedure can be used, for example, when, proceeding from the instantaneous motor vehicle position, multiple trajectories having different target positions, for example trajectories to different parking spaces, can be traveled, wherein some of the target positions, such as the parking spaces, may be occupied. In this case, it is possible, for example, to ascertain and provide only guidance data records that serve to guide the motor vehicle to one of the free target positions, such as a free parking space. As an alternative, it is possible, for example, that initially guidance data records for all target positions are provided to the motor vehicle, whereupon a guidance data record can be selected therefrom, as a function of the piece of occupancy information, by way of which the motor vehicle can be guided to a free target position. It is also possible, of course, to ascertain for positions other than the target position whether these are occupied. It can be detected as a function of the piece of occupancy information, for example, whether one or more segments of a trajectory are occupied, and a guidance data record can be ascertained for a trajectory, or a guidance data record in which no segment of the trajectory is occupied by a further motor vehicle to be taken into consideration can be selected.

The piece of occupancy information can be provided by the motor vehicle to be taken into consideration itself. The provision can take place directly to the motor vehicle, for example by way of Car2Car communication, or the memory device or via at least one further device. For example, the motor vehicle to be taken into consideration can provide the present position thereof to the memory device, so that this can directly be taken into consideration within the scope of the ascertainment and provision of the at least one guidance data record for the motor vehicle or be transmitted to the motor vehicle, so as to serve there in the selection of a guidance data record for actuating the vehicle device. The motor vehicle to be taken into consideration can determine the position thereof, for example, by way of a satellite-based navigation determination system. As an alternative, it is also possible that the piece of occupancy information is ascertained using sensors and is provided to the motor vehicle or the memory device. Sensors of the motor vehicle, of the motor vehicle to be taken into consideration and/or sensors provided by the infrastructure can be utilized for this purpose. For example, a sensor system of a parking garage can be used, which ascertains an occupancy of at least one parking space.

The path data record and/or the guidance data record can each describe, for at least one segment of the trajectory, coordinates of a starting point and/or an ending point of the respective segment and/or a path curvature and/or a steering angle in the respective segment. It is thus not necessary for the trajectory to be described by high resolution location data, but it may be described by multiple waypoints, which are connected, for example, via a predefined path curvature or a predefined steering angle.

It is possible that the relationship between the path data record or the guidance data record and the shape of the trajectory depends on the specific vehicle geometry of the motor vehicle or of the further motor vehicle. When a trajectory segment is described, for example, by the steering angle used or to be used, the resulting shape of the trajectory depends on the wheelbase, for example. It is thus possible that additionally, within the scope of the method according to the present disclosure, the at least one guidance data record can be ascertained and/or the vehicle device can be controlled as a function of at least one driving geometry parameter of a driving geometry of the motor vehicle. When the guidance data record is ascertained as a function of the driving geometry parameter, this may previously be provided to the memory device. This can be carried out by the motor vehicle, for example within the scope of polling guidance data records or signing the motor vehicle in with the memory device, for example when starting the motor vehicle. As an alternative, the driving geometry parameter can previously be stored on the memory device. For example, the driving geometry parameter can be provided by a user to the memory device, in particular via a web interface. As an alternative, it is possible to store driving geometry parameters assigned to the vehicle on the memory device before the motor vehicle is provided to a user. This can take place, for example, when the memory device is operated by a motor vehicle manufacturer or the manufacturer provides driving geometry parameters for the memory device. Taking the driving geometry parameter into consideration makes it possible to use path data records detected by a motor vehicle having a different driving geometry.

The driving geometry parameter can describe a wheelbase and/or a turning circle and/or a maximum steering angle of the motor vehicle. As was already described, the wheelbase is essential for the relationship between the trajectory and the steering angle. A turning circle or a maximum steering angle of the motor vehicle can limit which of the detected trajectories are even negotiable by the motor vehicle. These parameters can thus, in particular, be used within the scope of the selection of the trajectory for which a guidance data record is provided, or as a function of which the actuation of the vehicle device takes place, since trajectories that cannot be negotiated by the host vehicle can be discarded.

In the ascertainment of the path data record, a further driving geometry parameter describing the vehicle geometry of the motor vehicle negotiating the trajectory can be detected and transmitted to the memory device, whereupon the at least one guidance data record is ascertained and/or the vehicle device is controlled as a function of the further driving geometry parameter. If, for example, a steering angle is detected within the scope of the path data record, an actual path curvature of the trajectory or of the trajectory segment can be determined by way of the further driving geometry parameter, whereby the path data record can also be used by motor vehicles having different vehicle geometries.

It is possible to ascertain multiple path data records for multiple trajectories, wherein at least one of multiple user identifications is assigned to each of the path data records, wherein one of these user identifications, which is detected by the motor vehicle, is assigned to a user of the motor vehicle, whereupon only path data which is assigned to the detected user identification or at least one further predefined user identification is taken into consideration within the scope of the provision of the guidance data. The user identification may be detected, for example, by reading this out from a device assigned to the driver, for example a vehicle key having an integrated transceiver or a mobile communications device. As an alternative, it is possible that the user selects the user identification by an operating input on an operating device of the motor vehicle, for example by selecting a profile. The predefined user identification can be assigned to path data records that are public. However, it is also possible for users to provide all the path data records assigned to them, or parts thereof, to other users.

Preferably, a user identification is also detected during the detection of the path data by the respective motor vehicle, and the detected path data is assigned to this user identification. Host path data can be provided to further users via a web interface, for example. Assigning path data to a user identification makes it possible for a user to always have the path data records that were personally learned available, regardless of which motor vehicle is presently in use by the user.

In addition or as an alternative thereto, it is possible that at least one group of trajectories for which the path data is stored on the memory device is assigned to a certain infrastructure device or a certain territory, wherein the or a position detection device of the motor vehicle ascertains whether the motor vehicle is located in the territory or in a region assigned to the infrastructure device, wherein, in this case, all of the guidance data records assigned to the group of trajectories are transmitted to the motor vehicle and/or only trajectories that belong to the group are taken into consideration within the scope of the provision of the guidance data records. The described procedure makes it possible to provide public data records, for example for parking in a parking garage or in a parking lot, to a plurality of motor vehicles. Additionally, this facilitates the selection of path data records since only a selection between the path data records assigned to the territory or the region is required. If a selection of the trajectories or of the guidance data records used by the motor vehicle is carried out, for example manually as a function of a designation assigned to the trajectory or a target position, only those trajectories that are assigned to the region or the territory can be made available for selection.

In addition, the present disclosure relates to a motor vehicle which is configured to participate in the method according to the present disclosure as the motor vehicle and/or as the further motor vehicle. The motor vehicle comprises, in particular, a communication device for communicating with the memory device, and a control device for controlling the communication device and the vehicle device. The communication device and the vehicle device can be controlled by the control device so as to carry out the method according to the present disclosure.

Moreover, the present disclosure relates to a memory device which is configured to participate in the method according to the present disclosure as the memory device. The memory device can comprise at least one processing device or a network of processing devices, each having a respective memory assigned thereto, and at least one communication device for communicating with the motor vehicle or the further motor vehicle. The processing device or the processing devices can provide guidance data records for a plurality of users, each having a user identification assigned thereto, which allows the assigned path data to be assigned to certain users, as described above. The processing device or the processing devices can ascertain the guidance data records as a function of the path data records.

The motor vehicle and the memory device according to the present disclosure can, of course, be refined using the features described for the method according to the present disclosure, and vice versa.

Referring now to the FIGURE, the motor vehicle 1 is to be parked in the garage 2. The garage 2 is a two-car garage having two parking spaces 3, 4. The motor vehicle 1 comprises a control device 5, by way of which multiple vehicle devices 6, 7 can be actuated so as to guide the motor vehicle in an automated or assisted manner along previously learned trajectories 9, 10. The vehicle device 6 is an engine of the motor vehicle 1, and the vehicle device 7 is a steering system of the motor vehicle 1. Moreover, the control device 5 controls brakes (not shown) of the motor vehicle 1. If at least partially manual guidance of the motor vehicle 1 is desired, the control device 5 can actuate the vehicle device 8, a display device, to provide driving suggestions to the driver. In this way, the driver can be assisted in driving the motor vehicle along the previously learned trajectory 9, 10.

The method described hereafter is characterized in that the motor vehicle 1 can be guided not only along trajectories 9, 10 that were learned within the scope of a trip of the motor vehicle 1 itself, but also that guidance along trajectories 9, 10 learned by a further motor vehicle is possible. For a simple presentation of the method, it was assumed in the description below that the trajectories learned by the motor vehicle 1 are also utilized within the scope of the guidance of the motor vehicle 1. To the extent that an adaptation of the method is necessary when a further motor vehicle is used for learning the trajectories, this is pointed out in the appropriate passages of text.

The method starts with the trajectories 9, 10 to be learned being driven manually by a driver (not shown) of the motor vehicle 1. The trajectory 9 is used to park the motor vehicle 1 on the parking space 3, and the trajectory 10 is used to park the motor vehicle 1 on the parking space 4. For the sake of clarity, relatively simple trajectories 9, 10 are shown in the illustrated example, which each consist of three segments. In the segments 11, 12, the motor vehicle 1 moves straight ahead, in the segments 13, 14 a right-hand curve having a constant steering angle is negotiated, and in the segments 15, 16 the motor vehicle 1 is again moved straight ahead. The path data for the trajectories 9, 10 describe the respective coordinates of the starting and ending points 17 to 23 of the segments 11 to 16, and the respective steering angle used by the motor vehicle 1, for each of the segments 11 to 16 of the trajectories 9, 10. As an alternative, it would be possible to ascertain the path curvature, which can be calculated from the steering angle, instead of the steering angle.

The ending points 20, 23 of the segments 15, 16 correspond to the respective target points of the trajectories 9, 10 to which the motor vehicle is to be guided. The starting and ending points 17 to 23 are shown in the FIGURE so as to each correspond to a respective front center of the motor vehicle 1 when the motor vehicle 1 has reached the appropriate point. In an actual implementation, the motor vehicle positions are determined by a position determination device 24, such as a GPS sensor. In this case, the respective positions of this position determination device can be stored, which are shifted in relation to the front vehicle center.

After the trajectory has been driven, the respective path data record, which describes the trajectory as explained, is transmitted by the communication device 25 of the motor vehicle via the wireless communication link 27 to a vehicle-external memory device 26. In addition to the path data record, it is possible to transmit driving geometry parameters, which describe the driving geometry of the motor vehicle 1. For example, a wheelbase of the motor vehicle 1 can be transmitted. This can be used in the further course of the procedure for calculating a path curvature of the segments 11 to 16 from the respective steering angles, or for calculating a steering angle that a motor vehicle having a different vehicle geometry would have to use to achieve a corresponding path curvature. A corresponding calculation can be carried out by the memory device 26, in particular during polling of guidance data records by the motor vehicle 1, as will be described hereafter, or by the receiving motor vehicle within the scope of the control of the vehicle device.

The learned trajectories 9, 10 can subsequently be used by the motor vehicle 1 or by an arbitrary other motor vehicle. As described, it is possible to take different vehicle geometries of the motor vehicles into consideration in the process. For use by the motor vehicle, the memory device 26 provides at least one guidance data record, which is assigned to one of the trajectories 9, 10 and is ascertained as a function of the path data record describing the respective assigned trajectory 9, 10, to the motor vehicle 1 via the communication device 25.

In the simplest case, the guidance data record can be identical to the path data record. For example, the guidance data record can comprise the previously stored coordinates of the starting and ending points 17 to 23 of the segments 11 to 16 and the associated steering radii for one of the trajectories 9, 10. Preferably, however, it is already taken into consideration within the scope of the ascertainment of the guidance data record that the motor vehicles can have different driving geometries, which is to say, for example, different wheelbases, turning circles and/or maximum steering angles. For this purpose, the motor vehicle 1, within the scope of signing into the memory device 26, for example during starting of the motor vehicle 1, or within the scope of polling the at least one guidance data record, can transmit driving geometry parameters of the motor vehicle to the memory device 26, which takes these into consideration within the scope of the ascertainment of the at least one guidance data record. For example, it is possible that no guidance data records are provided for trajectories that cannot be negotiated by the motor vehicle 1 due to the maximum steering angle thereof or the turning circle thereof. Moreover, a steering angle, which is transmitted within the scope of the guidance data record, can be calculated as a function of the driving geometry parameter.

The FIGURE shows only two trajectories 9, 10, for which the path data is stored on the memory device 26. However, since the memory device 26 can serve as a memory device for a plurality of motor vehicles, it is possible for path data for a very large number of trajectories 9, 10 to be stored on the memory device 26. As a result, a guidance data record should not be generated and transmitted to the motor vehicle 1 for each trajectory for which path data is available. The number of ascertained and transmitted guidance data records can be reduced in a variety of ways. For example, the path data record can be linked to a respective user identification describing a user of the motor vehicle within the scope of the ascertainment of the path data record. A corresponding user identification can, for example, be provided to the motor vehicle 1 by a personalized vehicle key or a mobile communication device automatically, or by manual input of the user on an operating device of the motor vehicle 1, and be transmitted together with the path data to the memory device 26. Thereafter, it is possible to provide only guidance data records to the motor vehicle 1 which are assigned to trajectories for which the path data record includes an appropriate user identification. Additionally, it is possible to provide path data that is marked as public or was provided by other users to the user.

It is thus achieved by way of the described method that a certain user is able to use trajectories learned by him or her in multiple motor vehicles. If it is assumed that a single user learns relatively few trajectories, it is possible, for example, that a user manually selects, on an operating device of the motor vehicle, for example on the display device 8, which can be designed as a touch screen, for which of the trajectories guidance data records are to be calculated after a list of possible trajectories has been transmitted by the memory device 26, or that he or she selects, after a transmission of guidance data records for all trajectories leaned by him or her, an appropriate guidance data record which, as will be described hereafter, is to be used for guidance of the motor vehicle. For this purpose, the individual trajectories can be assigned plain text names, such as text strings. Alternatively, it is possible to identify the individual trajectories by way of the target points thereof.

Frequently, however, it is desired for the selection of a suitable trajectory to be carried out automatically or at least for the selection options of the user to be limited, so as to avoid protracted scrolling through a plurality of possible trajectories. It is thus possible that an ego position of the motor vehicle 1 is ascertained by the position determination device 24 and transmitted to the memory device 26, where it is evaluated within the scope of the selection of the at least one trajectory for which a guidance data record is to be ascertained. As an alternative, it is possible, of course, to transmit guidance data records for all trajectories to the motor vehicle 1, whereupon the control device 5 selects one or more from these guidance data records as a function of the ego position of the motor vehicle 1.

Two approaches shall be described by way of example for selecting trajectories as a function of the ego position, which can, of course, also be combined. A first option for reducing the number of trajectories is to assign groups of trajectories for which the path data is stored on the memory device to a respective certain infrastructure device or a certain territory. As a function of the ego position, it can be ascertained whether the motor vehicle is located in the territory or in a region assigned to the infrastructure device. In this way, only those trajectories that belong to the group may be considered within the scope of the provision of the guidance data records. For example, in the shown situation, only the trajectories 9, 10 assigned to the garage 2 may be taken into consideration, even if further trajectories were learned.

As an alternative or in addition, it is possible to assign a piece of position information describing at least one position assigned to the trajectories to each of the trajectories. This position can, for example, be the starting and/or ending points 17 to 23 of the segments 11 to 16, the target positions that agree with the ending points 20, 23, or other waypoints on the trajectories 9, 10. It is possible to provide only guidance data records for trajectories in which the piece of position information describes at least one position having a distance with respect to the ego position of the motor vehicle below a predefined limit value. This limit value can additionally be dependent on the direction and/or an orientation of the motor vehicle can be taken into consideration.

Another factor that is relevant for the selection of the trajectory for which a guidance data record is to be provided is whether the corresponding trajectory 9, 10 is freely negotiable, or whether a motor vehicle 28 to be considered is present on the trajectory 9, 10, in particular in the region of the respective target position. For example, in the situation shown in the FIGURE, both trajectories 9, 10 would initially be equivalent for the motor vehicle 1. However, a piece of occupancy information, which indicates the position of the motor vehicle 28 to be taken into consideration, can be transmitted by the motor vehicle 28 to be taken into consideration to the memory device 26. Within the scope of the provision of the at least one guidance data record, the memory device can thus ascertain that the target position of the trajectory 10 is occupied by the motor vehicle 28, and can thus transmit to the motor vehicle 1 a guidance data record that is assigned to the free trajectory 9.

If only a single guidance data record was transmitted to the motor vehicle 1, the vehicle devices 6 to 8 can subsequently be controlled directly, or upon confirmation by a user, as a function of this guidance data record. For example, the motor vehicle can be guided autonomously along the trajectory 9 so as to be parked on the parking space 3, or driving instructions for appropriate guidance can be output to a driver via the display device 8.

If multiple guidance data records are transmitted to the motor vehicle 1, one of these guidance data records is selected by the control device 5 of the motor vehicle 1 and thereafter is used to actuate the vehicle devices 6 to 8. A selection can be carried out manually by a user, for example by an operating input on the display device 8, which is designed as a touch screen. It is also possible for the corresponding selection to be carried out by a user located away from the motor vehicle, for example on a mobile communication device. Moreover, the described selection methods for selecting trajectories for which the guidance data records are to be provided can also be used downstream in the motor vehicle for selecting the guidance data records.

The described method thus makes it possible for trajectories learned by a motor vehicle 1 to be used by an arbitrary other motor vehicle 1. Additionally, it enables an automatic selection of one of the trajectories that was learned, for example by assisting a user in making such a selection.

The method was described within the scope of a relatively simple example, this being driven into a garage 2. It is possible, of course, for trajectories to be learned by a plurality of users and to be provided to a plurality of motor vehicles. This can be advantageous, for example, when a motor vehicle is to be parked automatically in a public parking area or in a parking garage. In this case, trajectories for a plurality of parking spaces can be learned by a plurality of different motor vehicles having different users. The parking area or the parking garage can comprise sensors, which ascertain whether parking spaces are free or occupied. Moreover a memory device can be provided in the parking space or parking area, or a memory device provided separately therefrom can take into consideration that the motor vehicle is located in the region of the parking area or of the parking garage. In this case, a guidance data record can be provided for the motor vehicle, which is used to guide the motor vehicle to one of the free parking spaces.

1.-14. (canceled)

15. A method for operating a motor vehicle, the method comprising:
ascertaining at least one path data record describing a respective traveled trajectory of a further motor vehicle;
transmitting the at least one path data record to a vehicle-external memory device;
detecting a driving geometry parameter describing a vehicle geometry of the motor vehicle negotiating the traveled trajectory;
transmitting the driving geometry parameter to the vehicle-external memory device;
ascertaining, by the vehicle-external memory device, at least one guidance data record for the motor vehicle as a function of a path data record describing the respective assigned trajectory, wherein each guidance data record is assigned to a trajectory of a plurality of trajectories;
providing, by the vehicle-external memory, the at least one guidance data record to the motor vehicle;
actuating the motor vehicle as a function of a selected guidance data record of the provided at least one guidance data record;
outputting a driving suggestion related to the trajectory assigned to the selected guidance data record to a driver of the motor vehicle; and
performing at least one driving intervention based at least in part on the driving suggestion;
wherein at least one of ascertaining the at least one guidance data record or actuating the motor vehicle is performed as a function of at least one driving geometry parameter.

16. The method according to claim 15, wherein ascertaining the at least one path data record comprises ascertaining path data records for a plurality of trajectories, wherein each trajectory of the plurality of trajectories is assigned at least one piece of position information describing at least one position assigned to the respective trajectory, and
wherein a selection criterion used to select the trajectory assigned to the selected guidance data record or the selected guidance data record depends on pieces of position information.

17. The method according to claim 16, further comprising ascertaining, by a position detection device of the motor vehicle, a piece of ego position information describing an ego position of the motor vehicle, wherein the selection criterion additionally depends on the piece of ego position information.

18. The method according to claim 16, wherein each piece of position information describes a target position at which the respective trajectory ends, and wherein the selection criterion depends on the target positions.

19. The method according to claim 16, wherein the selection criterion additionally depends on an operating input of a user detected on an operating device of the motor vehicle.

20. The method according to claim 15, further comprising ascertaining a piece of occupancy information that describes a position occupied by a motor vehicle to be taken into consideration, wherein at least one of the trajectory assigned to the selected guidance data record or the selected guidance data record is selected based at least in part on the occupancy information.

21. The method according to claim 15, wherein at least one of the path data record or the guidance data record describe, for at least one segment of the traveled trajectory, at least one of coordinates of a starting point of the respective segment, an ending point of the respective segment, a path curvature of the respective segment, or a steering angle of the respective segment.

22. The method according to claim 15, wherein at least one of ascertaining the at least one guidance data record or actuating the motor vehicle is performed as a function of at least one further driving geometry parameter related to a driving geometry of the motor vehicle.

23. The method according to claim 22, wherein the at least one further driving geometry parameter describes at least one of a wheelbase, a turning circle, or a maximum steering angle of the motor vehicle.

24. The method according to claim 15, further comprising ascertaining a plurality of path data records for a plurality of trajectories, wherein at least one of a plurality of user identifications is assigned to each of the path data records,
detecting, by the motor vehicle, a user identification from the plurality of user identifications assigned to a user of the motor vehicle, and
wherein ascertaining the at least one guidance data record comprises ascertaining the at least one guidance record based only on at least one of path data records assigned to the detected user identification, or at least one predefined user identification.

25. The method according to claim 15, further comprising:
storing at least one group of trajectories on the vehicle-external memory device, wherein the at least one group of trajectories is assigned to at least one of an infrastructure device or a physical territory;
ascertaining, by a position detection device of the motor vehicle, whether the motor vehicle is located in the physical territory or a region assigned to the infrastructure device; and
transmitting each guidance data record assigned to the at least one group of trajectories to the motor vehicle;
wherein ascertaining the at least one guidance data record comprises ascertaining the at least one guidance record based only on trajectories from the at least one group of trajectories.

26. A motor vehicle, comprising one or more computing devices configured to perform operations, the operations comprising:
ascertaining at least one path data record describing a respective traveled trajectory of a further motor vehicle, and transmitting the path data record to a vehicle-external memory device;
transmitting the at least one path data record to a vehicle-external memory device;
detecting a driving geometry parameter describing a vehicle geometry of the motor vehicle negotiating the traveled trajectory;
transmitting the driving geometry parameter to the vehicle-external memory device;
receiving at least one guidance data record from the vehicle-external memory device, wherein the at least one guidance data record for the motor vehicle is ascertained as a function of a path data record describing the respective assigned trajectory, and wherein each guidance data record is assigned to a trajectory of a plurality of trajectories;
actuating the motor vehicle as a function of a selected guidance data record of the provided at least one guidance data record;
outputting a driving suggestion related to the trajectory assigned to the selected guidance data record to a driver of the motor vehicle; and
performing at least one driving intervention based at least in part on the driving suggestion;
wherein the at least one of ascertaining the at least one guidance data record or actuating the motor vehicle is performed as a function of at least one driving geometry parameter.
